(19) United States
(12) Patent Application Publication
(10) Pub. No.: US 2005/0234617 A1
(43) Pub. Date: Oct. 20, 2005

(54) Driver support system

(76) Inventors: Andreas Kynast, Hildesheim (DE); Jens Faenger, Bernburg (DE)

Correspondence Address: KENYON & KENYON, ONE BROADWAY, NEW YORK, NY, 10004, US

(21) Appl. No.: 10/524,780

(22) PCT Filed: Oct. 6, 2003
(86) PCT No.: PCT/DE03/03298

§ 371 Date: Feb. 16, 2005

(30) Foreign Application Priority Data
Nov. 28, 2002 (DE) 10255436.6

(51) Int. Cl. G05D 1/00

(52) U.S. Cl. 701/36; 701/1

(57) ABSTRACT

A driver assistance system for a motor vehicle includes output means for outputting information to a vehicle driver of the motor vehicle and/or operating means for operation of the driver assistance system by the vehicle driver, and control means for controlling the information output and/or operation. Means for determining a workload state of the vehicle driver are provided; and the control means are embodied for controlling the information output and/or operation as a function of the workload state of the vehicle driver. A driver assistance system has the advantage that operation of the driver assistance system, and information output by the driver assistance system, are adapted to the workload of the vehicle driver, consequently avoiding overload or excessive distraction of the vehicle driver from traffic events, thus contributing to traffic safety.

### BACKGROUND INFORMATION

Driver assistance systems, in the form of vehicle navigation systems that output driving direction instructions in acoustic and/or optical form in order to guide a vehicle driver to a destination along a previously calculated route of travel, are known. Prior input of the destination by the vehicle driver, via an operator interface of the vehicle navigation system, is necessary for calculation of the route of travel. Since destination input while driving constitutes a considerable distraction from traffic events, suppression of operation of the device, in particular destination input, while the vehicle is being driven has been and is being discussed.

In a known development of such vehicle navigation systems, provision is made for the driving direction instructions to be outputted not at a predetermined distance before a turning point or general decision point (i.e. for example an expressway exit or intersection), but rather at an increasing distance from the decision point as the vehicle speed rises. The intended result is that a consistent reaction time for following the driving direction instructions is made available to the vehicle driver, regardless of the vehicle speed.

### SUMMARY OF THE INVENTION

A driver assistance system according to the present invention has the advantage that operation of the driver assistance system and information output by the driver assistance system are adapted to a particular workload of the vehicle driver, consequently avoiding overload or excessive distraction of the vehicle driver from traffic events. The invention thus contributes to traffic safety.

In an advantageous development of the invention, provision is made for the driver assistance system to have a profile memory for storing at least one user profile; and for information output and/or operation additionally to be controlled as a function of a user profile stored in the profile memory. Control of information output and/or operation can thus, in addition to the workload correlation, be individualized in user-specific fashion.

In summary, the invention thus makes possible, in consideration of the current driving situation, the driver's condition, and optionally the driver profile (i.e. the vehicle driver's workload resulting therefrom as a consequence of driving demands), an adaptation of the output strategies and information density of driving instructions in terms of the situation (e.g. frequency of messages, output medium, manner of presentation); a situation-specific adaptation of operating procedures (e.g. by limiting or inhibiting the functionality of interactions); simplified operation, since decisions are made by the system itself; and thus, ultimately, enhanced driving safety because the driver, in critical situations, can concentrate more on the actual driving task and is not distracted.

### BRIEF DESCRIPTION OF THE DRAWING

FIG. 1 is a block diagram of the portion of a driver information system that is important in terms of the invention, using the example of a vehicle navigation system.

### DETAILED DESCRIPTION

The invention will be explained below taking the example of a vehicle navigation system as an example of a driver information system. This does not, however, imply any limitation of the subject matter of the invention to vehicle navigation systems.

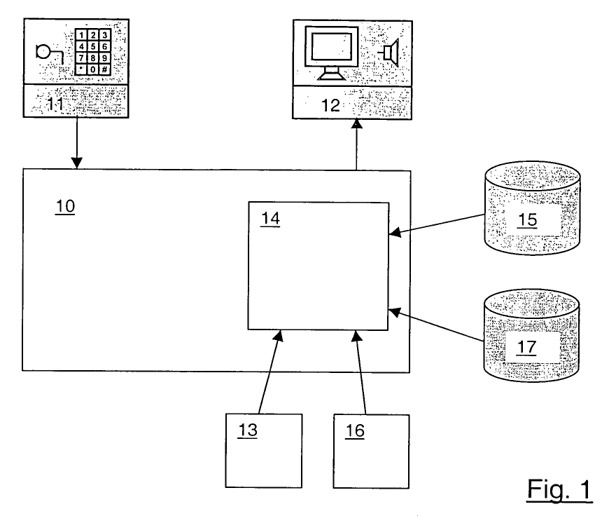

Vehicle navigation system 1 depicted in FIG. 1 encompasses a control system 10 that preferably is implemented in the form of software and is executed by a microprocessor.

Connected to the control system is an operating unit 11 that, as indicated in FIG. 1, encompasses operating elements in the form of buttons or keypads. As likewise indicated in FIG. 1, however, operating unit 11 can also, alternatively or in addition to the aforesaid operating elements, encompass a voice input device known per se. Lastly, operating unit 11, together with an output unit 12 likewise connected to the control system, can together constitute an operator interface (also called a man-machine interface or MMI), known per se, for the operation of vehicle navigation system 1.

The above-described operating unit 11 or operator interface serves in the context of the vehicle navigation system, for example, for input of a destination for subsequent route-of-travel calculation and destination guidance.

Output unit 12 connected to control system 10 can encompass both a display for optical indication of information and, alternatively or in addition thereto, an acoustic output. In the case of the vehicle navigation system, driving direction instructions are outputted in the context of the actual destination guidance along a calculated route of travel, for example, acoustically in the form of spoken instructions and/or in the form of directional arrows as an optical indication. The directional arrows can be displayed, for example, both as plain arrows or also against the background of a map depiction. In addition, in the context of the input of a destination, letters or names of destinations selectable via the operating elements are, for example, optically depicted on the display apparatus in a manner known per se.

Also connected to control system 10 is a sensor suite 13 for sensing vehicle operating data. Sensor suite 13 encompasses, for example, acceleration sensors for sensing longitudinal and transverse accelerations of the vehicle that occur as a result of acceleration and braking operations and during cornering. Such acceleration sensors are used in present-day navigation systems to determine a current vehicle position but also, for example, for accident detection in combination with airbag triggering. Sensor suite 13 further senses, for example, a current vehicle speed on the basis of a speedometer signal.

But sensor suite 13 also senses, for example, the switch positions of a light switch for high beams, fog lights, and rear fog lights, windshield wipers, response of the ABS (antilock braking system) in the event of hard vehicle deceleration, an external temperature, and other data that are not exhaustively listed here.

The current workload of the vehicle driver is inferred, from the data of sensor suite 13, in a driver condition detection system that is here embodied preferably as a software module of control system 10.

In a situation of little vehicle acceleration and a speed on the order of 80 to 130 km/h, for example, as is typical when driving calmly on expressways or secondary roads with few curves and little traffic, the driver condition detection system decides that the vehicle driver's workload is low. If greater longitudinal or transverse accelerations are recorded for the same speed values, this indicates increased traffic or a route with more curves, and consequently a greater driver workload. Similarly, for example, the fact that a rear fog light or the windshield wipers are switched on suggests an elevated need for concentration on the part of the vehicle driver, and thus a greater workload on the vehicle driver as a result of the driving task.

According to a preferred development of the invention, the driver condition detection system takes into account not only the vehicle data sensed by vehicle sensor system 13, but also contextual data taken from a contextual database 15. Contextual database 15 contains, for example, a digital road map such as the one common in navigation systems. On the basis of contextual database 15 and a current vehicle position identified by the position determination function of the vehicle navigation system, a determination can be made as to whether the vehicle is located, for example, on an expressway or a secondary road, or is passing through a town. This additional information can preferably be taken into account by driver condition detection system 14 in order to ascertain the vehicle driver's workload. For a vehicle speed of 100 km/h and a location on an expressway, for example, driver condition detection system 14 identifies a lesser workload than for the same speed on a narrow or poorly constructed secondary road.

Further guidelines regarding the workload imposed by the driving task are supplied by the nature of the route of travel. For example, as the vehicle approaches a segment with many curves or a dangerous intersection, the driver will then need to concentrate more on controlling the vehicle. From this in combination with the navigation information, a prognosis for driver stress can be prepared.

According to a further development of the invention, driver data, such as a current body temperature or skin surface conductivity as an indication of perspiration, as sensed by a corresponding driver sensor suite 16, can additionally be taken into account by driver condition detection system 14 in order to ascertain the driver's workload.

Lastly, according to a particularly advantageous development of the invention that can be combined with all the embodiments and developments described above, information from a profile database 17 can additionally be employed to ascertain the current workload of the vehicle driver. The user's preferences are stored in the profile data of profile database 17. These include, for example, information as to which output forms he or she prefers in particular situations.

Additionally, for example, the situation-related output of route guidance instructions desired by the driver can be learned by the system. For that purpose, it monitors which display forms or voice guidance modes the user selects in particular situations, for example arrow display and detailed voice output in poor weather, or a detailed map depiction and short voice instructions when traffic density is high. It stores this information in the driver profile in profile database 17. With this self-taught experience, the driver assistance system can provide the vehicle driver with assistance adapted to the situation.

Based on detection of the vehicle driver's current workload on the basis of detection and evaluation of the driving situation with reference to vehicle operating data and optionally contextual data, the driver profile, and optionally driver data, control system 10 performs the following functions:
Selection of the situation-specific voice output strategy in consideration of driver preferences. This encompasses the frequency of navigation instructions as well as their level of detail, ranging from simple directional indications (“left here,” “now right”) to long, detailed procedural instructions (“In 500 meters, please turn left onto Hildesheimer Strasse. It is a sharp turn so please reduce speed.”).
Selection of the situation-specific visual route guidance strategy in consideration of driver preferences. This encompasses the decision as to what is displayed. The system can thus decide, for example, whether to show an arrow, a map, or a three-dimensional depiction of the area. It also decides which particular screen (center console or combi instrument) to use for display, and which location on it.
Adaptation of the visual output information density. An arrow, for example, can be displayed normally or in perspective. The same applies to the map, where decisions must additionally be made regarding map scale and detail. In the interest of clarity, for example, all roads that are small or are not on the route of travel can be removed from the map. For a three-dimensional output, the display can contain every building or only important orientation points.
In some circumstances, selection of output strategies for other output media, e.g. noise output, haptic outputs (e.g. force feedback at the steering wheel).
Situation-specific adaptation of operating procedures. This includes inhibiting all interactions that should not currently be operable for safety reasons. Other interactions are depicted in simplified fashion by inhibiting or removing operating elements for unimportant functions.

The manner of operation of the invention will be elucidated once again below with reference to a concrete application example.

The driver enters a destination via the operating elements of the navigation system and drives off. The road is clear and the weather good. Because the driving task is simple, the driver condition detection system infers a normal workload. Route guidance instructions are therefore given frequently and in quite detailed fashion, e.g. “In one kilometer, please turn left onto Robert-Bosch-Strasse.” In addition, the map display is detailed and shows even small roads.

After a while the driving situation deteriorates because a heavy rain begins. The system detects this by way of the selection of a high windshield-wiper speed. Because the driver must concentrate more on the driving task, i.e. because the vehicle driver's workload has increased, from now on the driving directions are given in short and pithy fashion, e.g. “One kilometer, left.” This short form decreases the amount of information that is outputted, and thus distracts the driver less from the actual driving task. The frequency of the messages also decreases, and the information content on the map display is reduced, for example by the removal of all roads not relevant for destination guidance.

Later on the traffic density increases, so that the vehicle driver must frequently adjust his speed. From the frequent braking and acceleration actions, the system infers a very high vehicle driver workload. For safety reasons, it deactivates all functions of the navigation system that are not immediately necessary, including all settings interactions. This prevents the driver from being distracted from driving events by the performance of inputs.

1-2. (canceled)

3. A driver assistance system for a motor vehicle, comprising:
at least one of: (a) means for outputting information to a vehicle driver of the motor vehicle, and (b) means for operation of the driver assistance system by the vehicle driver;
means for determining a workload state of the vehicle driver; and
means for controlling at least one of (a) the information output and (b) the operation, as a function of the workload state of the vehicle driver.

4. The driver assistance system according to claim 3, further comprising a profile memory for storing at least one user profile, and wherein the controlling is a further function of the user profile stored in the profile memory.
